(19) United States
(12) Patent Application Publication
(10) Pub. No.: US 2020/0363600 A1
(43) Pub. Date: Nov. 19, 2020

(54) Luminaire with Lens Alignment End Caps

(71) Applicant: SIGNIFY HOLDING B.V., Eindhoven (NL)

(72) Inventor: Andrew L. Robota, Senoia, GA (US)

(21) Appl. No.: 16/412,208

(22) Filed: May 14, 2019

(51) Int. Cl. G02B 7/00; G03B 17/56; F21V 5/04; F21K 9/69

(52) U.S. Cl. CPC G02B 7/003; F21K 9/69; F21V 5/04; G03B 17/568

(57) ABSTRACT

A lens alignment end cap of a luminaire includes a base wall and a sidewall that extends substantially perpendicular to the base wall along a perimeter of the base wall. At least a portion of the sidewall is configured to support an edge of a lens therein. Further, the lens alignment end cap includes a centering tab that is disposed on the portion of the sidewall that is configured to support the edge of the lens. The centering tab is configured to centrally align the lens that is disposed between the lens alignment end cap and another lens alignment end cap that is disposed opposite to the lens alignment end cap and to minimize a sliding of the lens between the lens alignment end cap and the other lens alignment end cap.

### TECHNICAL FIELD

The present disclosure relates generally to lighting solutions, and more particularly to a luminaire with lens alignment end caps.

### BACKGROUND

Luminaires often include end caps that are configured to cover the open ends (e.g., lateral ends) of a luminaire and to support and retain a lens therebetween. For example, one edge of the lens may be disposed in and supported within one end cap and an opposite edge of the lens may be disposed in and supported within an opposite end cap. Typically, the end caps are configured to have a depth ‘d’ (shown in FIG. 1) and the lens is configured such that a length thereof is slightly less than the distance between the inner base walls of the end caps which allows the lens to slide within and between the end caps. The ability to freely slide between the end caps allow the lens to be decoupled from the luminaire without removing the end caps. For example, a lens 102 that is disposed between two end caps (104a, 104b) may be decoupled from the end caps (104a, 104b) by sliding one edge of the lens 102 towards the inner base wall of the end cap 104b that supports said edge of the lens 102 as illustrated in FIG. 2. In said example, when said edge of the lens 102 is pushed towards the end cap 104b, an opposite edge of the lens 102 is released from the opposite end cap 104a which in turn creates a gap 106 between the opposite end of the lens and the opposite end cap 104a as illustrated in FIG. 1. Then, the lens 102 may be decoupled from the luminaire by pulling on the end of the lens 102 that is released from the opposite end cap 104a to slide the lens 102 out of the luminaire.

Even though the design of the lens and the end caps as described above may allow the lens to be removed from the luminaire without removing the end caps, said design also allows the lens to freely slide between the end caps. The free sliding of the lens between the end caps may affect the proper alignment of the lens between the end caps. For example, the lens may slide towards one end cap such that the lens is biased towards said end cap more than the opposite end cap which may affect the aesthetic appearance of the luminaire. Further, the free sliding of the lens between the end caps may cause the lens to inadvertently disengage from the luminaire, for example, if the lens slides all the way towards one end cap and causes the other edge thereof to be released as illustrated in FIGS. 1 and 2. Such disengagement may create a safety hazard, for example if the disengaged lens falls on a user. Furthermore, the gap 106 that is formed between the end cap and the edge of the lens that is released therefrom may result in light leakage from the luminaire therethrough.

The free sliding of the lens between the end caps may be prevented by using a longer lens that substantially matches the distance between the end caps and snugly fits between the end caps. While the longer lens may prevent a free sliding of the lens between the end caps, the longer lens may require the end caps of the luminaire to be removed each time the lens is to be removed or disengaged from the luminaire.

This background information is provided to reveal information believed to be of possible relevance to the present disclosure. No admission is necessarily intended, nor should be construed, that any of the preceding information constitutes prior art against the present disclosure.

### SUMMARY

In one aspect, the present disclosure relates to a luminaire that includes an end cap that is configured to cover an end of the luminaire. The end cap includes a base and a sidewall that extends along a perimeter of the base and is substantially perpendicular to the base. Further, the end cap includes a centering tab that is disposed on the sidewall to centrally align a lens that is disposed in between the end cap and another end cap of the luminaire. The other end cap is disposed opposite to the end cap. The sidewall of the end cap supports an edge of the lens and another sidewall of the other end cap supports an opposite edge of the lens.

In another aspect, the present disclosure relates to a luminaire that includes a first end cap that is configured to cover a first end of the luminaire. The first end cap includes a first centering tab that is disposed on a first sidewall of the first end cap. Further, the luminaire includes a second end cap that is disposed opposite to the first end cap and configured to cover a second end of the luminaire. The second end cap includes a second centering tab that is disposed on a second sidewall of the second end cap. The second end is opposite to the first end. Furthermore, the luminaire includes a lens that is coupled to the first end cap and the second end cap and is disposed between the first centering tab of the first end cap and the second centering tab of the second end cap.

In yet another aspect, the present disclosure relates to an end cap of a luminaire. The end cap includes a base, a sidewall that extends along a perimeter of the base and is substantially perpendicular to the base, and a centering tab that is disposed on the sidewall to centrally align a lens that is disposed in between the end cap and another end cap of the luminaire. The other end cap being disposed opposite to the end cap. The sidewall of the end cap supports an edge of the lens and another sidewall of the other end cap supports an opposite edge of the lens.

These and other aspects, objects, features, and embodiments, will be apparent from the following description and the appended claims.

### BRIEF DESCRIPTION OF THE FIGURES

The foregoing and other features and aspects of the present disclosure are best understood with reference to the following description of certain example embodiments, when read in conjunction with the accompanying drawings, wherein:

FIGS. 1 and 2 illustrate expanded cross-section views of opposite ends of a luminaire with a lens having one end that is slid all the way into one existing end cap of the luminaire and an opposite end of the lens that is released from an opposite existing end cap of the luminaire consequently, in accordance with an embodiment of a prior art luminaire;

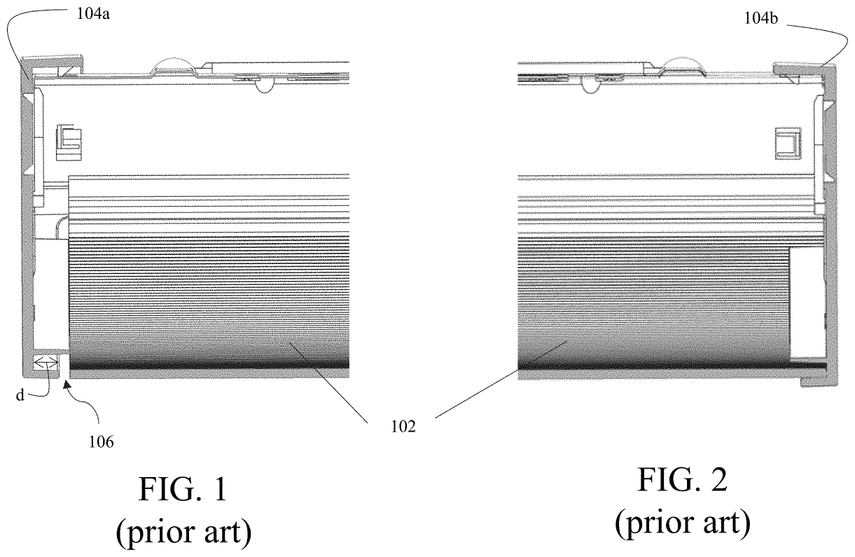

FIG. 3 illustrates a perspective view of an example luminaire comprising an example lens alignment end cap, in accordance with example embodiments of the present disclosure;

FIG. 4 illustrates a perspective view of the example lens alignment end cap, in accordance with example embodiments of the present disclosure;

FIG. 5 illustrates a cross-section view of the example lens alignment end cap of FIG. 4, in accordance with example embodiments of the present disclosure;

FIG. 6 illustrates a cross-section view of the example luminaire of FIG. 3 along an X-X′ axis, in accordance with example embodiments of the present disclosure;

FIG. 7 illustrates an expanded cross-section view of a portion of the luminaire of FIG. 3 that exemplifies the coupling of a lens to the example lens alignment end cap of the luminaire, in accordance with example embodiments of the present disclosure; and

FIGS. 8 and 9 illustrate expanded cross-section views of opposite ends of the luminaire of FIG. 3 with the lens being centrally aligned between opposite example lens alignment end caps of the luminaire, in accordance with example embodiments of the present disclosure.

The drawings illustrate only example embodiments of the present disclosure and are therefore not to be considered limiting of its scope, as the present disclosure may admit to other equally effective embodiments. The elements and features shown in the drawings are not necessarily to scale, emphasis is instead placed on clearly illustrating the principles of the example embodiments. Additionally, certain dimensions or positions may be exaggerated to help visually convey such principles.

### DETAILED DESCRIPTION OF EXAMPLE EMBODIMENTS

The present disclosure describes a luminaire with lens alignment end caps. The lens alignment end caps of the present disclosure are configured such that a lens that is disposed therebetween is centered without any tools or any human interaction. That is, the lens alignment end caps eliminate the need for an end user having to center the lens by using an eyeball estimate. Further, the lens alignment end caps of the present disclosure prevent free sliding of the lens therebetween. That is, the lens alignment end caps of the present disclosure prevent the lens from being biased to one lens alignment end cap and consequently being released from the opposite lens alignment end cap which in turn creates a gap through which light may leak out from the luminaire. Furthermore, the lens alignment end caps of the present disclosure prevent the lens that is disposed therebetween from inadvertently slipping/sliding out of or decoupling from the luminaire. In other words, the lens alignment end caps of the present disclosure ensure that the edges of the lens are always retained inside of the lens alignment end caps. Additionally, the lens alignment end caps are configured to allow a user to remove the lens from the luminaire without removing the lens alignment end caps.

In other word, the lens alignment end caps of the present disclosure allow the lens to be centered therebetween and prevent the lens from being inadvertently decoupled from the luminaire, while also allowing the lens to be decoupled from the luminaire without having to remove the lens alignment end caps.

In one example, the luminaire includes a first end cap, a second end cap that is disposed opposite to the first end cap, and a lens that is disposed between the first end cap and the second end cap. Each of the first end cap and the second end cap includes a centering tab that is configured to centrally align the lens that is disposed therebetween without the use of any tools. In particular, a first edge of the lens is disposed in and supported by the first end cap and a second opposite edge of the lens is disposed in and supported by the second end cap such that the lens is disposed between the centering tab of the first end cap and the centering tab of the second end cap. The centering tabs of the first end cap and the second end cap are configured to minimize the sliding of the lens therebetween with some allowable tolerance. Minimizing the sliding between the first end cap and the second end cap using the centering tabs prevents the lens from being biased to one end cap (the first end cap or the second end cap) and a resulting decoupling of the lens from the opposite end cap and/or formation of the gap 106 between the end cap and the lens that allows a light leak therethrough.

To remove the lens from the luminaire, a force may be applied to the lens to clear the centering tabs. Once the centering tabs are cleared, additional space is available in each of the first end cap and the second cap to slide the lens between the first end cap and the second end cap such that the lens can be biased towards the first end cap or the second end cap. Accordingly, once the lens clears the centering tabs, the lens may be slid towards the first end cap or the second end cap to release an opposite edge of the lens from a respective end cap. For example, if the first edge of the lens is slid towards the first end cap, then, the second edge of the lens is released from the second end cap which allows the lens to be decoupled from the luminaire. In other words, the lens disposed between the lens alignment end caps of the preset disclosure does not get inadvertently decoupled from the luminaire unless a user interacts with the lens, i.e., applies a force thereon to clear the centering tabs and slides the lens as described above.

The term ‘centered’, ‘centrally aligned’, or ‘central aligning’ as used herein may generally refer to an alignment of a lens between two end caps such that a substantially equal portion of the lens is disposed in both the end caps. A lens aligned as described above may also visually appear to be centered, i.e., not biased to one side, between the end caps.

Example embodiments of the luminaire with the lens alignment end caps will be described more fully hereinafter with reference to the accompanying drawings that describe representative embodiments of the present technology. If a component of a figure is described but not expressly shown or labeled in that figure, the label used for a corresponding component in another figure can be inferred to that component. Conversely, if a component in a figure is labeled but not described, the description for such component can be substantially the same as the description for a corresponding component in another figure. Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

The technology of the luminaire with the lens alignment end caps may be embodied in many different forms and should not be construed as being limited to the embodiments set forth herein; rather, these embodiments are provided so that this disclosure will be thorough and complete, and will fully convey the scope of the technology to those appropriately skilled in the art. Even though the present disclosure may describe the lens alignment end caps as being used with linear luminaires, one of skill in the art can understand and appreciate that in other example embodiments, the lens alignment end caps may be used with any appropriate type of luminaires that include a lens that is disposed between the end caps thereof and at least a portion of lens is supported by the end caps. The lens alignment end caps may be configured to replace any appropriate end caps in any appropriate luminaire where the lens is supported on the end caps and disposed therebetween.

The luminaire with the lens alignment end caps (or components thereof) described herein can be made of one or more of a number of suitable materials to allow the luminaire, the lens alignment end caps, and/or other associated components thereof to meet certain standards, tests (e.g., light leakage or photometric test), cost requirements, and/or regulations while also maintaining durability in view of the one or more conditions under which the luminaire, the lens alignment end caps, and/or other associated components thereof can be exposed. Examples of such materials can include, but are not limited to, plastic, fiberglass, acrylic, etc.

Further, components of the luminaire with the lens alignment end caps (or portions thereof) described herein can be made from a single piece. In addition, or in the alternative, components of the luminaire with the lens alignment end caps (or portions thereof) can be made from multiple pieces that are coupled to each other. In such a case, the multiple pieces can be coupled to each other using one or more of a number of coupling methods, including but not limited to adhesives, compression fittings, mating threads, and slotted fittings, etc. One or more pieces that are coupled to each other can be coupled to each other in one or more of a number of ways, including but not limited to fixedly, hingedly, removeably, slidably, and threadably.

Terms such as “first”, “second”, “third”, “top”, “bottom”, “side”, “end”, and “within” are used merely to distinguish one component (or part of a component or state of a component) from another. Such terms are not meant to denote a preference or a particular orientation, and are not meant to limit embodiments of the luminaire. In the following detailed description of the example embodiments, numerous specific details are set forth in order to provide a more thorough understanding of the present disclosure. However, it will be apparent to one of ordinary skill in the art that the luminaire with the lens alignment end caps of the present disclosure may be practiced without these specific details. In other instances, well-known features have not been described in detail to avoid unnecessarily complicating the description.

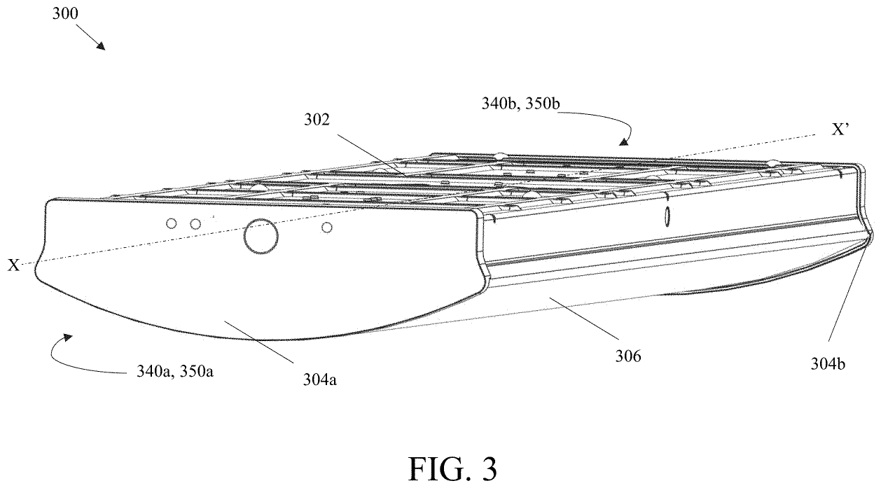

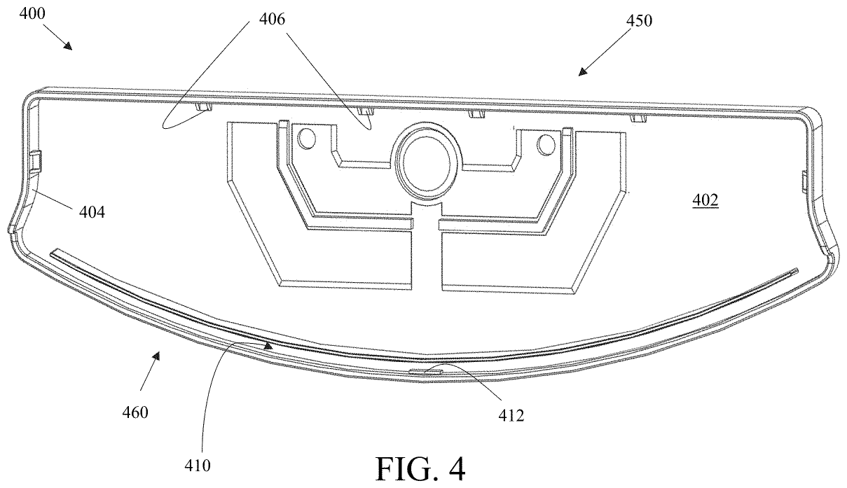

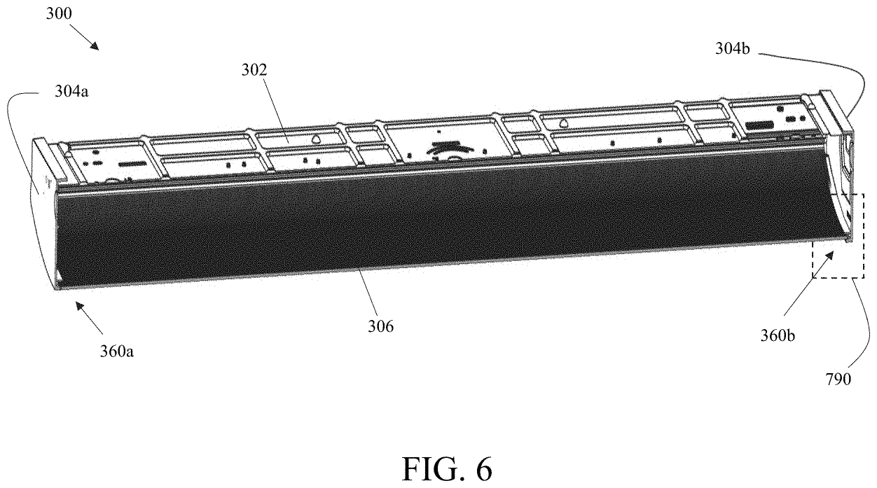

Turning now to the figures, example embodiments of an example luminaire with the example lens alignment end caps (hereinafter ‘end caps’) will be described in connection with FIGS. 3-9. Referring to FIGS. 3-9, an example luminaire 300 of the present disclosure may include a back plate 302, a first lens alignment end cap 304a (hereinafter ‘first end cap 304a’) that is coupled to and disposed at a first end 340a of the back plate 302, and a second lens alignment end cap 304b (hereinafter ‘second end cap 304b’) that is coupled to and disposed at a second end 340b of the back plate 302 that is opposite to the first end 340a. The first end cap 304a may be configured to cover a first end 350a (e.g., lateral end) of the luminaire 300 and the second end cap 304b may be configured to cover a second end 350b (e.g., lateral end) of the luminaire 300. Further, as illustrated in FIGS. 6 and 8-9, the luminaire 300 may include a lens 306 that is coupled to and disposed in between the first end cap 304a and the second end cap 304b such that the lens 306 is centrally aligned between the first end cap 304a and the second end cap 304b. As illustrated in FIG. 6, a first edge 360a of the lens 306 may be disposed in and supported by the first end cap 304a of the luminaire 300 and the second edge 360b of the lens 306 may be disposed in and supported by the second end cap 304b of the luminaire 300. The first end cap 304a and the second end cap 304b may be described below in greater detail in association with FIGS. 4-5 and 7.

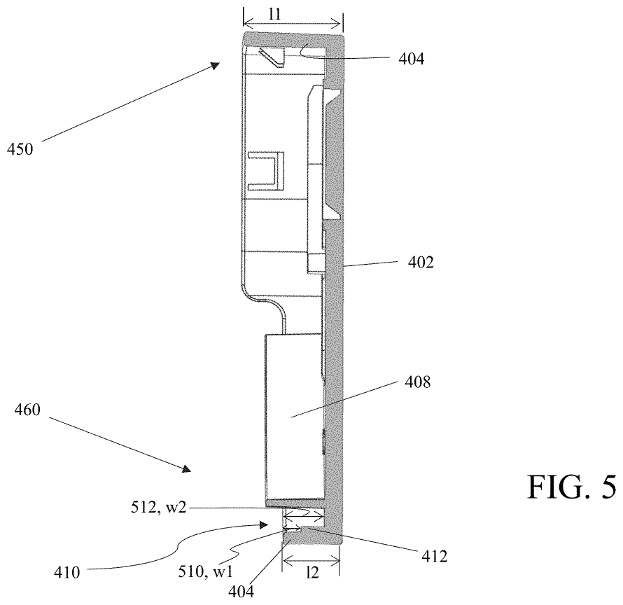

FIG. 4 illustrates an example lens alignment end cap 400 (hereinafter ‘end cap 400’) and FIG. 5 illustrates a cross-section view of the end cap 400 in accordance with an example embodiment of the present disclosure. The end cap 400 of FIGS. 4-5 corresponds to the first end cap 304a and to the second end cap 304b of FIGS. 3 and 6-9 and the description of the end cap 400 equally applies to the first end cap 304a and to the second end cap 304b of the luminaire 300.

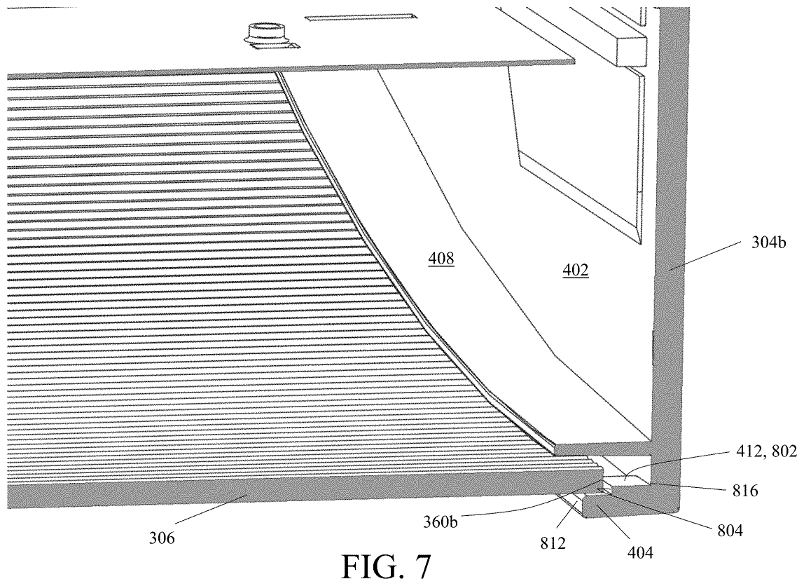

Referring to FIGS. 4-5, the end cap 400 may include a base wall 402 (interchangeably referred to as ‘base’) and a sidewall 404 that is substantially perpendicular to the base wall 402 and disposed along a perimeter of the base wall 402. The end cap 400 includes a first portion 450 that may be configured to couple the end cap 400 to the back plate 302 of the luminaire 300 and a second portion 460 that may be configured to couple the end cap 400 to the lens 306. Accordingly, the first portion 450 (e.g., top portion) of the end cap 400 may include coupling tabs 406 that are disposed on the sidewall 404. The coupling tabs 406 may be configured to mate with complementary slots or notches in the back plate 102 to couple the end cap 400 to the back plate 102 of the luminaire 300. Similarly, the second portion 460 (e.g., bottom portion) of the end cap 400 may be contoured based on the shape of the lens 306 that is to be coupled to the end cap 400. In the example embodiment illustrated in FIGS. 3-9, the lens may have a curved shape and accordingly, the second portion 460 of the end cap 400, i.e., the portion of the sidewall 404 and the base wall 402 that defines the second portion 460 may have a curved shape that substantially matches the curved shape of the lens 306. The first portion 450 of the end cap 400 may be disposed opposite to the second portion 460 of the end cap 400. Furthermore, as illustrated in FIG. 5, a width ‘11’ (distance measured from base wall 402 to the outer edge 812 (shown in FIG. 7) of the sidewall 404) of the portion of the sidewall 404 that defines the top portion 450 of the end cap 400 may be larger than a width ‘12’ of the portion of the sidewall 404 that defines the bottom portion 460 of the end cap 400.

Additionally, the end cap 400 may include a light leak wall 408 (also interchangeably referred to as ‘internal wall’) that is disposed adjacent the second portion of the end cap 400. In particular, the light leak wall 408 may be offset from the portion of the sidewall 404 that defines the second portion 460 of the end cap 400 such that a lens receiving cavity 410 is formed therebetween. The lens receiving cavity 410 may be configured to receive and support and edge (360a, 360b) of the lens 306 therein. The light leak wall 408 may be disposed on the base wall 402 such that the light leak wall 408 extends out of the base wall 402 and is substantially perpendicular thereto. Further, the light leak wall 408 may follow a contour of the portion of the sidewall 404 that defines the second portion 460 of the end cap 400. That is, the light leak wall 408 may be curved substantially similar to the portion of the sidewall 404 that defines the second portion 460 of the end cap 400.

Further, the end cap 400 may include a centering tab 412 that is disposed within the lens receiving cavity 410. As illustrated in FIG. 7, the example centering tab 412 of the present disclosure may be a block that is disposed at a joint 816 between the base wall 402 and the sidewall 404. The example centering tab 412 may include a first surface 802 that is offset from the sidewall 404 and extends from the base wall 402 towards the outer edge 812 of the sidewall 404, but not all the way to the outer edge 812. The first surface 802 may be substantially perpendicular to the base wall 402. Further, the centering tab 412 may include a second surface 804 that is offset from the base wall 402 and extends from the sidewall 404 towards the light leak wall 408, but not all the way to the light leak wall 408. The second surface 804 of the centering tab 412 may be substantially perpendicular to the sidewall 404 and the first surface 802 of the centering tab 412.

As illustrated in FIG. 5, the centering tab 412 may be configured and disposed in the lens receiving cavity 410 such that the lens receiving cavity 410 widens above the centering tab 412, the width being measured from the outer edge 812 of the sidewall 404 to the base wall 402 of the end cap 400. As illustrated in FIG. 5, a width ‘w1’ of a first portion 510 of the lens receiving cavity 410 that extends from the outer edge 412 of the sidewall 404 to the second surface 804 of the centering tab 400 is narrower than a width ‘w2’ of a second portion 512 of the lens receiving cavity 410 that extends from the outer edge 812 of the sidewall 404 to the base wall 402.

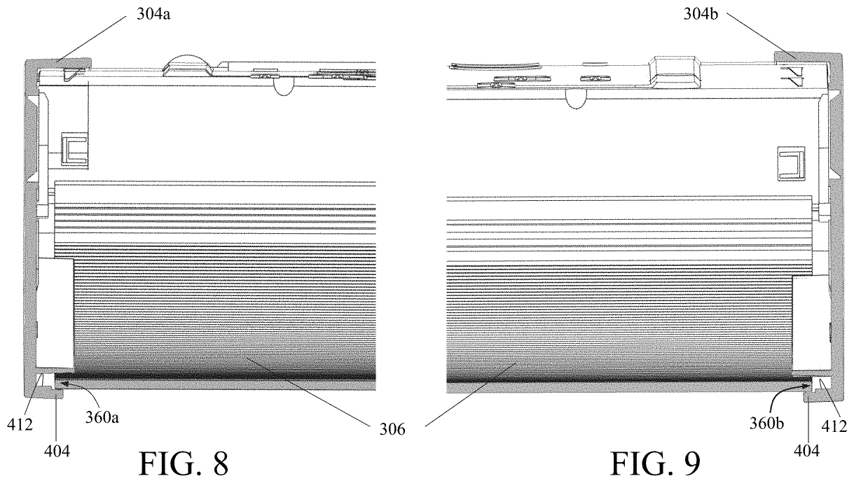

The centering tab 412 may prevent a lens 306 from sliding all the way to the base wall 402 of the end cap 400 when the lens 306 is disposed in the first portion 510 of the lens receiving cavity 410 as illustrated in FIGS. 8 and 9, while allowing the lens 306 to slide all the way to the base wall 402 of the end cap 400 when the lens 306 is adjusted to clear the centering tab 412 and the lens 306 is disposed above the centering tab 412 in the second portion 512 of the lens receiving cavity 410.

As illustrated in FIGS. 6-9, in the luminaire 300 of the present disclosure, the lens 306 may be disposed between the centering tab 412 of the first end cap 304a and the centering tab of the second end cap 304b. That is, the first edge 360a of the lens 306 may be disposed on the sidewall 404 of the first end cap 304a between the outer edge 812 thereof and the second surface 804 of the centering tab 412 of the first end cap 304a; and the second edge 360a of the lens 306 may be disposed on the sidewall 404 of the second end cap 304b between the outer edge 812 thereof and the second surface 804 of the centering tab 412 of the second end cap 304b The centering tabs 412 allow the lens 306 to be centered between the two end caps (304a, 304b) without the use of any tools and minimize the sliding of the lens 306 between the two end caps (304a, 304b). The minimized sliding of the lens 306 between the end caps (304a, 304b) may prevent the inadvertent decoupling of the lens 306 from the luminaire 300 and/or the formation of the gap 106 between the end cap (304a or 304b) and the respective edge (360a, 360b) of the lens 306 through which light may leak from the luminaire 300.

To remove the lens 306 from the luminaire 300, a user may apply a force on the lens 306 in the direction of the light leak walls 408 of the end caps (304a, 304b). The lens 306 may be flexible. Accordingly, when the force is applied to the lens 306, the lens 306 may flex such that the lens 306 clears the centering tabs and is disposed above the centering tabs 412 of the end caps (304a, 304b) in the second portion 512 of the lens receiving cavity 410. Once the lens 306 is disposed above the centering tabs 412 of the end caps (304a, 304b) and in the second portion 512 of the lens receiving cavities 410 thereof, the user may slide the lens 306 towards either the first end cap 304a or the second end cap 304b till the first edge 360a or the second edge 360b of the lens 306 engages the base wall 402 of the first end cap 304a or the second end cap 304b, respectively. As one of the edges (360a or 360b) of the lens 306 is slid towards the base wall 402 of the respective end cap (304a or 304b) in which the edge is disposed, the opposite edge of the lens 306 may be released from the respective end cap in which the opposite end is disposed. For example, if the first edge 360a of the lens 306 is slid towards the base wall 402 of the first end cap 304a, the opposite edge 360b of the lens 306 may be released from the opposite second end cap 304b. As the edge of the lens is released from a respective end cap, a gap 106 may be formed therebetween. A user may access the released edge through the gap 106 to pull the lens 306 out of the luminaire 300 therethrough without having to remove the end caps (304a, 304b) from the luminaire 300.

Even though the present disclosure describes each end cap comprising a single centering tab, one of skill in the art can understand and appreciate that in other example embodiments, each end cap may include more than one centering tab or a centering tab in a different location along the sidewall without departing from a broader scope of the present disclosure. In another example embodiment, only one of the two end caps can have the centering tab. Further, even though the present disclosure describes a centering tab, an end cap, and a lens having a specific shape, one of skill in the art can understand and appreciate that in other example embodiments, the centering tab, the end caps, and the lens may have any other appropriate shape based on the type of luminaire without departing from a broader scope of the present disclosure. Furthermore, even though the present disclosure describes that the end caps include a light leak wall, one of skill in the art can understand and appreciate that in other example embodiments, the end caps may not include the light leak wall without departing from a broader scope of the present disclosure.

Although example embodiments are described herein, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A luminaire comprising:
an end cap that is configured to cover an end of the luminaire, the end cap comprising:
a base;
a sidewall that extends along a perimeter of the base and is substantially perpendicular to the base; and
a centering tab that is disposed on the sidewall to centrally align a lens that is disposed in between the end cap and another end cap of the luminaire, the other end cap being disposed opposite to the end cap,
wherein the sidewall of the end cap supports an edge of the lens and another sidewall of the other end cap supports an opposite edge of the lens.

2. The luminaire of claim 1, wherein the end cap further comprises an internal wall that is disposed on the base and offset from the sidewall such that the internal wall defines a lens receiving cavity between the internal wall and a portion of the sidewall, and wherein the centering tab is disposed in the lens receiving cavity.

3. The luminaire of claim 2, wherein the end cap supports the edge of the lens in the lens receiving cavity.

4. The luminaire of claim 2:
wherein the centering tab is positioned at a joint between the base and the portion of the sidewall, and
wherein the centering tab extends in a first direction from the base towards an outer edge of the sidewall and in a second direction from the sidewall towards the internal wall, the first direction and the second direction being substantially perpendicular to each other.

5. The luminaire of claim 2, wherein the internal wall is substantially perpendicular to the base, and wherein the internal wall is configured to prevent light from leaking out of the luminaire along a perimeter of the end cap.

6. The luminaire of claim 3, wherein a space between a top surface of the centering tab and the internal wall extends to the base wall, and wherein the space is configured to receive the edge of the lens therein to remove the lens from the luminaire.

7. The luminaire of claim 1, wherein the lens is a flexible lens.

8. The luminaire of claim 2, wherein the centering tab is disposed in the lens receiving cavity of the end cap such that the lens receiving cavity widens above the centering tab.

9. The luminaire of claim 2, wherein the end cap further comprises coupling tabs that are disposed on the sidewall thereof, and wherein the coupling tabs are configured to couple the end cap to a housing of the luminaire.

10. A luminaire comprising:
a first end cap that is configured to cover a first end of the luminaire, the first end cap comprising a first centering tab that is disposed on a first sidewall of the first end cap;
a second end cap that is disposed opposite to the first end cap and configured to cover a second end of the luminaire, the second end cap comprising a second centering tab that is disposed on a second sidewall of the second end cap,
wherein the second end is opposite to the first end; and
a lens that is coupled to the first end cap and the second end cap and is disposed between the first centering tab of the first end cap and the second centering tab of the second end cap.

11. The luminaire of claim 10, wherein the lens comprises a first edge that is disposed on the first sidewall of the first end cap adjacent the first centering tab and a second edge that is disposed on the second sidewall of the second end cap adjacent the second centering tab.

12. The luminaire of claim 10, wherein each of the first end cap and the second end cap comprise coupling tabs that are configured to couple the first end cap and the second end cap to the luminaire.

13. The luminaire of claim 10, wherein the lens is flexible.

14. The luminaire of claim 10:
wherein the first centering tab is positioned at a joint between a first base and the first sidewall, and
wherein the first centering tab extends in a first direction from the first base towards an outer edge of the first sidewall and in a second direction from the first sidewall towards a light leak wall of the first end cap that is offset from the first sidewall, the first direction and the second direction being substantially perpendicular to each other.

15. An end cap of a luminaire, the end cap comprising:
a base;
a sidewall that extends along a perimeter of the base and is substantially perpendicular to the base; and
a centering tab that is disposed on the sidewall to centrally align a lens that is disposed in between the end cap and another end cap of the luminaire, the other end cap being disposed opposite to the end cap,
wherein the sidewall of the end cap supports an edge of the lens and another sidewall of the other end cap supports an opposite edge of the lens.

16. The end cap of claim 15, wherein the end cap further comprises an internal wall that is disposed on the base and offset from the sidewall such that the internal wall defines a lens receiving cavity between the internal wall and a portion of the sidewall, and wherein the centering tab is disposed in the lens receiving cavity.

17. The end cap of claim 16, wherein the end cap supports the edge of the lens in the lens receiving cavity.

18. The end cap of claim 16:
wherein the centering tab is positioned at a joint between the base and the portion of the sidewall, and
wherein the centering tab extends in a first direction from the base towards an outer edge of the sidewall and in a second direction from the sidewall towards the internal wall, the first direction and the second direction being substantially perpendicular to each other.

19. The end cap of claim 16, wherein the internal wall is substantially perpendicular to the base, and wherein the internal wall is configured to prevent light from leaking out of the luminaire along a perimeter of the end cap.

20. The end cap of claim 16, wherein the centering tab is disposed in the lens receiving cavity of the end cap such that the lens receiving cavity widens above the centering tab.
